(19) United States
(12) Patent Application Publication
(10) Pub. No.: US 2026/0105035 A1
(43) Pub. Date: Apr. 16, 2026

(54) Concurrent Defragmentation For Database Persistent Memory Region

(71) Applicant: Oracle International Corporation, Redwood Shores, CA (US)

(72) Inventors: Zhuoyue Wang, New York City, NY (US); Sylvia Winters, Menlo Park, CA (US); Junhui Li, Menlo Park, CA (US); Teck Hua Lee, San Mateo, CA (US); Agnivo Saha, Belmont, CA (US); Aurosish Mishra, Foster City, CA (US); Yu Li, Foster City, CA (US); Juan Garduno, Guadalajara (MX); Murali Murugesan, Fremont, CA (US)

(21) Appl. No.: 18/916,925

(22) Filed: Oct. 16, 2024

(51) Int. Cl. G06F 16/215; G06F 16/23; G06F 16/27

(52) U.S. Cl. CPC G06F 16/215; G06F 16/2343; G06F 16/275

(57) ABSTRACT

A defragmentation process is provided for contiguous persistent or volatile memory regions. The defragmentation process selects and moves extents, updates extent maps, and ensures all read/write operations are consistent and uninterrupted. The defragmentation process can be applied to online maintenance defragmentation, online on-demand defragmentation, or offline defragmentation. The illustrative embodiments provide a source-destination mapping algorithm that allows for optimal defragmentation outcome with least amount of space relocation. In some embodiments, a cost-based greedy algorithm is used for source-destination mapping. Quiesce and unquiesce mechanisms allow for fine-grained access control for the extent currently being relocated by defragmentation.

### TECHNICAL FIELD

The illustrative embodiments relate to defragmenting extents in persistent or volatile memory in database software. More specifically, the illustrative embodiments relate to ensuring efficient defragmentation while offering high concurrency, data consistency, and availability.

### BACKGROUND

With an in-memory database system, a single database can efficiently support mixed workloads, delivering optimal performance for transactions while simultaneously supporting real-time analytics and reporting. This is possible due to a “dual-format” architecture that enables data to be maintained in both the existing row format, for online transaction processing (OLTP) operations, and a purely in-memory columnar format, optimized for analytical processing. The database maintains full transactional consistency between the row and the columnar formats, just as it maintains consistency between tables and indexes. Almost all objects in the database are eligible to be populated into in-memory representations.

The term persistent memory (PMEM) is used to describe technologies that allow programs to access data as memory, directly byte-addressable, while the contents are non-volatile, preserved across power cycles. PMEM has aspects that are like memory, and aspects that are like storage, but it does not typically replace either memory or storage. Instead, PMEM is a third tier, used in conjunction with memory and storage. Systems containing PMEM can provide faster start-up times, faster access to large in-memory datasets, and often improved total cost of ownership.

PMEM regions, often used for high-performance computing, can suffer from intra-extent fragmentation over time. Unlike volatile memory, persistent memory usually retains data longer, making efficient management crucial. This fragmentation leads to inefficient use of memory and can significantly degrade database performance. Existing solutions, typically designed for volatile memory environments or uniform size extents, do not adequately address the unique intra-extent fragmentation issues in PMEM.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Further, it should not be assumed that any of the approaches described in this section are well-understood, routine, or conventional merely by virtue of their inclusion in this section.

### BRIEF DESCRIPTION OF THE DRAWINGS

In the drawings:

FIG. 1 is a flowchart illustrating operation for defragmenting extents in persistent or volatile memory in accordance with an embodiment.

FIG. 2A illustrates a hierarchical extent structure in accordance with an embodiment.

FIG. 2B illustrates an allocated extent and managing parent extents in a hierarchical extent structure in accordance with an embodiment.

FIG. 2C illustrates an allocated extent and managing parent extents and child extents in a hierarchical extent structure in accordance with an embodiment.

FIG. 3 is a block diagram illustrating an extent map in accordance with an embodiment.

FIG. 4 is a flowchart illustrating operation of a cost-based algorithm for selecting source extent and destination extent pairs for defragmentation in accordance with an embodiment.

FIG. 5 is a block diagram that illustrates a computer system upon which aspects of the illustrative embodiments may be implemented.

FIG. 6 is a block diagram of a basic software system that may be employed for controlling the operation of a computer system upon which aspects of the illustrative embodiments may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

The illustrative embodiments introduce a background defragmentation process for contiguous persistent or volatile memory regions. The defragmentation process selects and moves extents, updates extent maps, and ensures all read/write operations are consistent and uninterrupted. The defragmentation process effectively reduces fragmentation, optimizing memory utilization and performance.

The defragmentation process can be applied to online maintenance defragmentation, online on-demand defragmentation, or offline defragmentation. An online maintenance defragmentation mode is initiated at regular intervals and systematically processes every memory “bucket” to perform defragmentation. A bucket is a collection of contiguous extents, with each extent being exclusively associated with a single bucket, and an extent is a number of contiguous allocation units that are allocated for storing a specific type of information. An online on-demand defragmentation mode is triggered when memory fragmentation exceeds a certain threshold. If no request has been made to defragment the same bucket, a defragmentation request is submitted to the background infrastructure, and the request is then processed asynchronously in the background. Unlike online defragmentation, which requires serialization and safe memory access techniques, an offline defragmentation mode does not suffer from the latency associated with concurrency. The illustrative embodiments provide a source-destination mapping algorithm that allows for optimal defragmentation outcome with least amount of space relocation.

In some embodiments, a cost-based greedy algorithm is used for source-destination mapping. The process utilizes source and destination extents to ensure minimal disruption, calculating the optimal mapping and moving the least amount of data to achieve maximum defragmentation.

In some embodiments, quiesce and unquiesce mechanisms allow for fine-grained access control for the extent currently being relocated by defragmentation. Once an extent is quiesced, new writers are prevented, and existing writers will be drained. Concurrent readers are always allowed. Quiesce/unquiesce allows the component to remain partially operational while some extents are being moved.

The defragmentation process of the illustrative embodiments is more efficient than logically copying rows, because the process minimizes the amount of data moved by optimizing source-destination mappings. A logical entity usually spans multiple memory buckets. Relocating a logical entity requires relocating data on all memory buckets. This operation can be expensive and wasteful. Thus, the illustrative embodiments improve efficiency.

The process also ensures minimal disruption to ongoing operations by maintaining data readability throughout the defragmentation. Therefore, the illustrative embodiments attempt to provide minimal disruption. This process can handle varying extent sizes, unlike solutions limited to uniform extent sizes, allowing for more flexible and efficient memory utilization. Thus, the illustrative embodiments provide flexibility compared to uniform extent sizes.

The defragmentation process can be performed in the background without taking the system offline, ensuring continuous operation and availability. Furthermore, automatic updating of persistent memory and volatile extent maps during copying allows for real-time updates, avoiding the need for lengthy downtime associated with offline defragmentation.

### Shared-Nothing Database System

An example computing environment in which aspects of the embodiments can be implemented is a shared-nothing database system. Implementation of a shared-nothing database system is described in detail in U.S. patent application Ser. No. 17/070,277, entitled “A SYSTEM AND METHOD OFR AN ULTRA HIGHLY AVAILABLE, HIGH PERFORMANCE, PERSISTENT MEMORY OPTIMIZED, SCALE-OUT DATABASE,” filed Oct. 14, 2020, now U.S. Pat. No. 11,550,771, the entire contents of which are hereby incorporated by reference as if fully set forth herein.

In a shared-nothing database system, parallelism and workload balancing are increased by assigning the rows of each table to “slices,” and storing multiple copies (“duplicas”) of each slice across the persistent storage of multiple nodes of the shared-nothing database system. When the data for a table is distributed among the nodes of a shared-nothing system in this manner, requests to read data from a particular row of the table may be handled by any node that stores a duplica of the slice to which the row is assigned.

According to an embodiment, for each slice, a single duplica of the slice is designated as the “primary duplica.” All DML operations (e.g., inserts, deletes, updates, etc.) that target a particular row of the table are performed by the node that has the primary duplica of the slice to which the particular row is assigned. The changes made by the DML operations are then propagated from the primary duplica to the other duplicas (“secondary duplicas”) of the same slice.

### Slices

As mentioned above, a “slice” is an entity to which rows of a table are assigned. The assignment of rows to slices may be made in a variety of ways, and the techniques described herein are not limited to any particular row-to-slice assignment technique. For example, the table may have a primary key, and each slice may be assigned the rows whose primary keys fall into a particular range. In such an embodiment, a table whose primary key is alphabetic may have its rows assigned to three slices, where the first slice includes rows whose primary key starts with letters in the range A-K, the second slice includes rows whose primary key starts with letters in the range L-T, and the third slice includes rows whose primary key starts with letters in the range U-Z.

As another example, the row-to-slice assignment may be made using a hash function. For example, a hash function that produces hash values in the range 1-3 may be used to assign rows to three slices. The slice to which any given row is assigned is determined by the hash value produced when the hash function is applied to the row's primary key.

For any given table, the number of slices to which its rows are assigned may vary based on a variety of factors. According to one embodiment, the number of slices is selected such that no single slice will store more than 1 gigabyte of data. Thus, as a general rule, the more data contained in a table, the greater the number of slices to which the rows of the table are assigned.

In situations where a table has no designated primary key column, the database system creates and populates a column with values that may serve as the primary key for the purpose of assigning the rows of the table to slices. The values for such a system-created primary key column may be, for example, an integer value that increases for each new row. This is merely an example of how system-generated primary key values can be created, and the techniques described herein are not limited to any particular method of generating primary key values.

### Duplicas

A “duplica” is a stored copy of a slice. According to one embodiment, every slice has at least two duplicas. As mentioned above, each slice has one duplica that is designated as the primary duplica of the slice, and one or more secondary duplicas. Requests to read data from a slice may be performed by any node whose persistent storage has a duplica of the slice. However, requests to perform DML operations (e.g., insert, delete, update) on a slice are only performed by the node whose persistent storage has the primary duplica of the slice.

### Hosts

As used herein, the term “host” refers to the hardware components that constitute a shared-nothing node. For example, a host may be a computer system having one or more processors, local volatile memory, and local persistent storage. The volatile memory and persistent storage of a host are “local” in that I/O commands issued by the host to the volatile memory and persistent storage do not travel over inter-host network connections. As shall be described in greater detail hereafter, one host may interact directly over inter-host network connections with the volatile memory or persistent storage of another host through the use of Remote Direct Memory Access (RDMA) operations.

### Persistent Storage

As mentioned above, each host has local persistent storage on which the duplicas that are hosted by the host are stored. The persistent storage may take a variety of forms, including but not limited to magnetic disk storage, NVRAM, NVDIMM, FLASH/NVMe, and persistent memory (PMEM) storage. In addition, the persistent storage may include a combination of storage technologies, or storage tiers, such as PMEM and magnetic disk storage, or PMEM and FLASH/NVMe. For the purpose of explanation, it shall be assumed that the persistent storage used by the hosts is NVRAM. However, the techniques described herein are not limited to any persistent storage technology.

### Memory Allocation

In accordance with the illustrative embodiment, at the finest granularity, data is stored in memory in “allocation units.” One allocation unit corresponds to a specific number of bytes of physical memory space. The next level of logical space is an “extent.” An extent is a number of contiguous allocation units that are allocated for storing a specific type of information, such as a database component in a duplica. A component may be, for example, an index, a row heap, a row storage, transaction heap, or a mapping to log record. The level of logical database storage above an extent is called a “bucket.” A bucket is a set of extents, each of which is allocated for a specific data structure and all of which are stored in the same duplica. A bucket is a collection of contiguous extents, with each extent being exclusively associated with a single bucket, and an extent is a number of contiguous allocation units that are allocated for storing a specific type of information. In the context of space management, a bucket serves as a unit of concurrency rather than being associated exclusively with a specific component. A bucket can contain extents for various components. Additionally, while an extent is allocated to store a specific type of information for a duplica component, it typically does not represent the entirety of that component in most cases. For example, data of each table is stored in its own data bucket, while data of each index is stored in its own index bucket. If the table or index is partitioned into slices, each slice is stored in its own bucket.

A duplica is a unit is replication. From the space management perspective, a duplica consists of a number of extents, and extents can be of different sizes. However, there is a limit on how many extents each duplica can track. Therefore, the smaller the extent, the sooner the duplica will run out of space, at which point the duplica must be split. The extent count limit is associated with each duplica component. Specifically, a duplica has a limit on the number of extents it can manage. Duplica splitting occurs when the used size of a duplica exceeds a certain threshold. This process is independent of the number of extents being allocated. Furthermore, some database components may perform better with larger extents. Thus, there is an advantage to having more contiguous free allocation units to allow for extents of larger sizes.

### Concurrent Defragmentation

The illustrative embodiments introduce a background defragmentation process for contiguous memory regions. The process comprises eight phases: Start, Select, Waiting, Copying, Acknowledging, Finalizing, Reclamation and End. During these phases, the defragmentation module selects and moves extents, updates extent maps, and ensures all read/write operations are consistent and uninterrupted. This process effectively reduces fragmentation, optimizing memory utilization and performance.

The defragmentation method can be applied to:
Online Maintenance Defragmentation: This mode is initiated at regular intervals (e.g., every 10 or 30 second) and systematically processes every PMEM bucket to perform defragmentation.
Online On-demand Defragmentation: This mode is triggered when memory fragmentation exceeds a certain threshold or a duplica runs out of space for a particular type of database component. If no request has been made to defragment the same PMEM bucket (as indicated by a post_defrag flag), a defragmentation request is submitted to the background infrastructure, and the post_defrag flag is set. The request is then processed asynchronously in the background. Online on-demand defragmentation may be performed for a single memory bucket. In one embodiment, the defragmentation process determines a number of consecutive free allocation units that will result from the defragmentation process for a bucket and performs the online on-demand defragmentation if the number of consecutive free allocation units is sufficient for a particular allocation, such as allocation of a given database component.
Offline Defragmentation: During this mode, new writes are not accepted. Offline defragmentation may be performed bucket-by-bucket for all or a subset of memory buckets. Unlike online defragmentation, which requires serialization and safe memory access techniques, offline defragmentation does not suffer from the latency associated with concurrency. The source-destination mapping algorithm in this invention allows for optimal defragmentation outcome with least amount of space relocation.

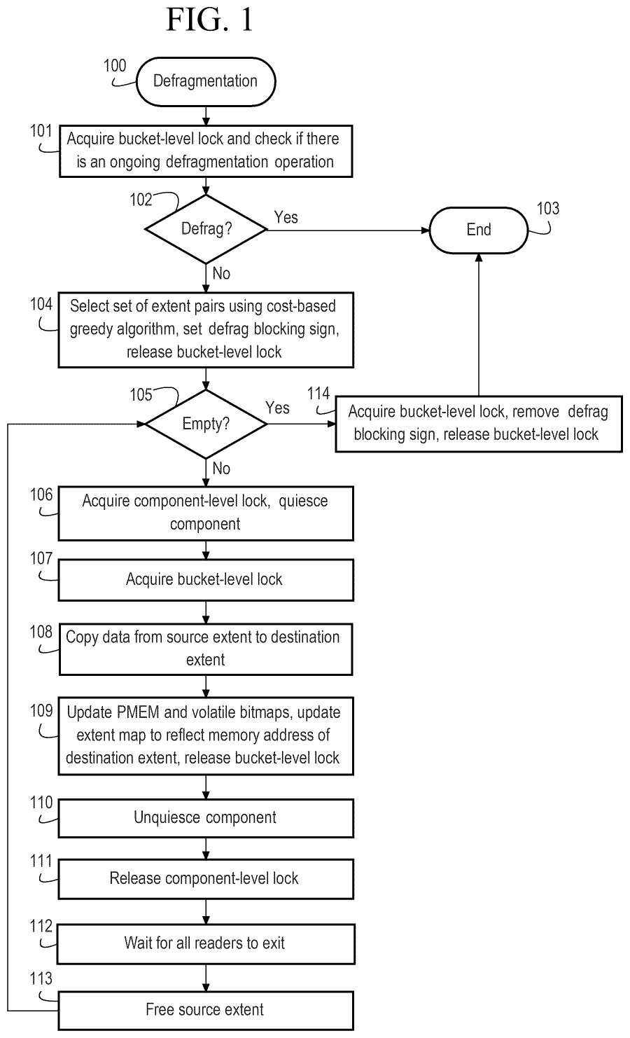

FIG. 1 is a flowchart illustrating operation for defragmenting extents in persistent or volatile memory in accordance with an embodiment. Operation begins when defragmentation of a bucket of memory is initiated (block 100). In a start phase, the defragmentation process acquires a bucket-level lock and checks if there is an ongoing defragmentation on the bucket (e.g., using the blocking sign is_defraging) (block 101). The blocking sign is managed through a flag variable safeguarded by multiple levels of locks. For is_defrag or post_defrag operations, the flag is specifically protected and serialized using a bucket-level lock. The defragmentation process determines if there is an ongoing defragmentation on the bucket (block 102). If concurrent defragmentation is detected (block 102: Yes), then operation ends (block 103). The lock is released immediately if a defragmentation process is ongoing and move to the end phase.

If no concurrent defragmentation is detected (block 102: No), then operation proceeds to the selection phase. In the selection phase, the defragmentation processes a set of extent pairs using a cost-based greedy algorithm, sets the defrag blocking sign, and releases the bucket-level lock (block 104). In the selection phase, the process selects an extent allocated to a component as the source extent and a same-sized free extent as the destination extent using the cost-based greedy algorithm. This algorithm minimizes the amount of data moved to achieve maximum defragmentation, as will be discussed in further detail below. At the end of the selection phase, the process sets the blocking sign is_defraging and releases the bucket lock.

The defragmentation process processes each source extent and destination extent pair in the set of extent pairs. As each pair is processed, it is removed from the set. Thus, the defragmentation process determines whether the set of extent pairs is empty (block 105). If the set is not empty (block 105: No), then the defragmentation process begins the waiting phase and acquires a duplica component-level lock and quiesces the component so all writers observe it through a mechanism to wait all writers to the source extent is gone and then prevent new writers to the source extent (block 106).

Next, in the copying phase, the defragmentation process acquires a memory bucket-level lock and ensures the destination slot is still empty (block 107). The defragmentation process physically copies data from the source extent to the destination extent (block 108). The defragmentation process then updates the PMEM and volatile bitmaps, updates the extent map to reflect the actual memory address, and releases the memory bucket-level lock at the end of the copying phase (block 109).

In the acknowledgment phase, the defragmentation process unquiesces the component, acknowledging the extent map changes so that the component will use the same extent ID to map to the destination extent, and opens the destination extent for new writes (block 110).

In the finalizing phase, the defragmentation process releases the duplica component-level lock, allowing allocation to proceed (block 111).

In the reclamation phase, the defragmentation process uses a mechanism to wait for all readers to finish reading the source extent. The defragmentation process waits a sufficient amount of time for all readers to finish their reads (block 112). Once complete, the defragmentation process frees the source extent (block 113) and proceeds to the next defragmentation pair, if available, thus returning operation to block 105. In an alternative embodiment, the defragmentation process can free all source extents after the end phase.

If there are no more extent pairs, i.e., the set of extent pairs is empty (block 105: Yes), then in the end phase, the defragmentation process acquires the bucket-level lock, lifts the is_defraging blocking sign, and releases the bucket-level lock (block 114), marking the end of the defragmentation process for this bucket. Thereafter, operation ends (block 103).

### Blocking Sign

In some embodiments, to minimize disruption during concurrent allocation, the defragmentation process uses a blocking sign interrupt_defrag. The blocking sign is a flag variable contained within the bucket structure. This flag is responsible for managing concurrent space allocation, which occurs when multiple database components attempt to allocate extents to the same bucket simultaneously. Such operations may involve various components, including row heaps, indexes, and others. Concurrent space allocation will de-prioritize the concurrent defragmentation operation with the blocking sign interrupt_defrag. If there is no available space in other buckets, concurrent allocation will still allocate space from the bucket with the blocking sign interrupt_defrag set. If space is allocated, the blocking sign interrupt_defrag will be removed, indicating there has been at least one allocation from the memory bucket that is being defragmented. This serves two purposes: allowing other concurrent space allocators to utilize the memory bucket without de-prioritizing and allowing the defragmentation process to detect that the defragmentation has been interrupted. The process can then decide about whether to continue or give up.

### Hierarchical Volatile Bitmap

In some embodiments, the system employs a hierarchical structure for tracking extent allocation status. When an extent of a certain size is allocated, all smaller extents within the same region are marked as allocated. Additionally, the corresponding larger extent that encompasses the PMEM address is also marked as allocated. The volatile bitmap includes a bit for each extent in the hierarchical structure, where the bit has a first value (e.g., 0) for a free extent and a second value (e.g., 1) for an allocated extent.

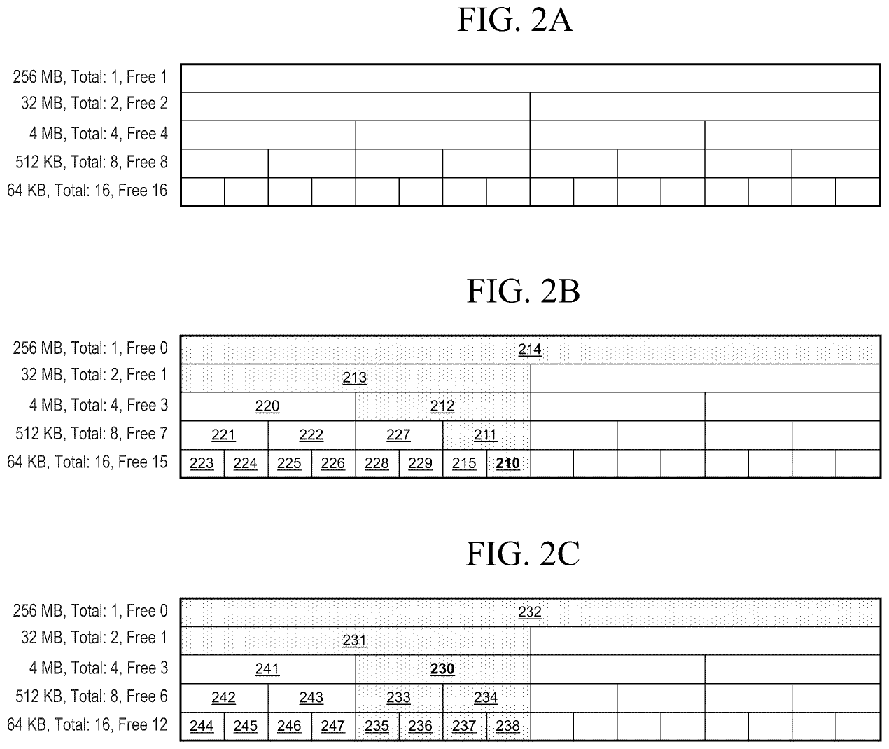

FIG. 2A illustrates a hierarchical extent structure in accordance with an embodiment. In the depicted example, the memory region of 256 MB can be divided into one extent of size 256 MB. The one extent of 256 MB has two children, each being an extent of size 32 MB. Each extent of size 32 MB has two children, each being an extent of size 4 MB. Each extent of size 4 MB has two children, each being an extent of size 512 KB. Each extent of size 512 KB has two children, each being an extent of size 64 KB. In this example, each bit of the volatile bitmap has a first value (e.g., 0), indicating that all extents are free. Note that in reality a 256 MB extent could consist of eight 32 MB extents, a 32 MB extent could consist of eight 4 MB extents, a 4 MB extent could consist of eight 512 KB extents, and a 512 KB extent could consist of eight 64 KB extents. FIGS. 2A-2C illustrate extents in a 1:2 ratio for simplicity and to avoid the complexity of visualizing numerous extents (e.g., 4096 65 KB extents).

FIG. 2B illustrates an allocated extent and managing parent extents in a hierarchical extent structure in accordance with an embodiment. In this example, extent 210 is allocated for a specific type of information, such as a database component. In FIGS. 2B and 2C, allocated extents are represented using reference numbers in bold font. With extent 210 allocated, extents 211-214 cannot be allocated, because they are parents of extent 210 and encompass extent 210. For example, if one were to allocate extent 212, then data written to extent 212 would overwrite data in extents 210 and 211. On the other hand, extents 215 and 220-229 are free and can be allocated. Thus, in the volatile bitmap, extents 215 and 220-229 have a first value (e.g., 0), indicating the extents are free, and extents 210-214 have a second value (e.g., 1), indicating the extents are allocated.

FIG. 2C illustrates an allocated extent and managing parent extents and child extents in a hierarchical extent structure in accordance with an embodiment. In this example, extent 230 is allocated for a specific type of information, such as a database component. As stated above, with extent 230 allocated, extents 231 and 232 cannot be allocated, because they are parents of extent 230 and encompass extent 230. For example, if one were to allocate extent 231, then data written to extent 231 would overwrite data in extent 230. Furthermore, extents 233-238 cannot be allocated, because they are encompassed by extent 230. For example, if one were to allocate extent 237, then data written to extent 237 would overwrite data in a portion of extent 230. On the other hand, extents 241-247 are free and can be allocated. Thus, in the volatile bitmap, extents 241-247 have a first value (e.g., 0), indicating the extents are free, and extents 230-238 have a second value (e.g., 1), indicating the extents are allocated.

### Extent Map

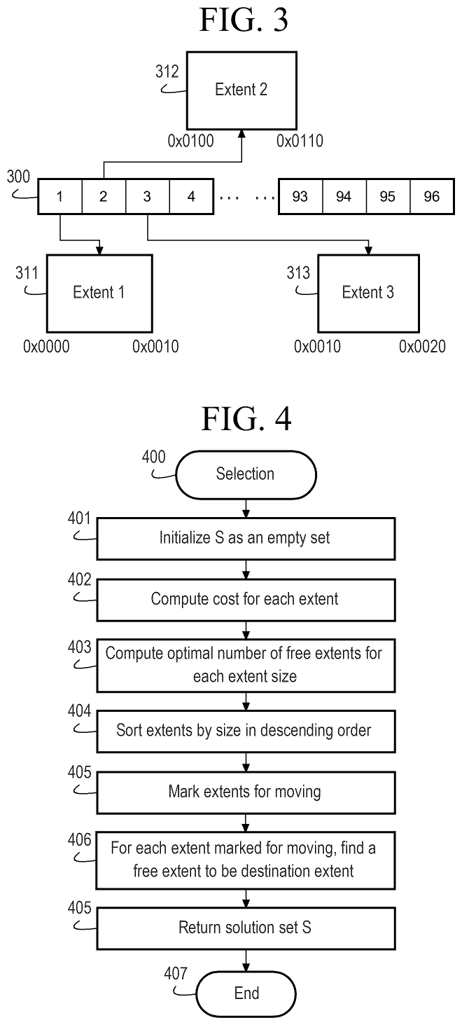

The extent map is an array maintained for each database component in a duplica. The extent map uses the extent ID as the key and the extent address as the value. The components reference the extent ID to locate the extent address and perform further operations. FIG. 3 is a block diagram illustrating an extent map in accordance with an embodiment. In the depicted example, extent map 300 is an array with extent ID 1 corresponding to extent 1 311, which includes address 0x0000 to 0x0010. Extent ID 2 corresponds to extent 2 312, which includes addresses 0x0100 to 0x0110. Extent ID3 corresponds to extent 3 313, which includes address 0x0010 to 0x0020.

The process of moving an extent includes physically copying the contents of the extent to a free destination extent having the same size. For example, the contents of extent 3 313 can be copied to a free extent that includes addresses 0x0220 to 0x0230. After copying the contents to the destination extent, extent map 300 is updated such that extent ID3 points to the address of the destination extent, 0x0220 in the above example. Then extent 3 313 can be freed for subsequent allocation.

### Space Management Lock

Space is presented to user objects as duplicas, which function like multiple semi-independent table copies. Each duplica comprises various components, including rows, transactions, and logs. Locks are applied at the duplica component level to initiate allocation or deallocation processes. During defragmentation, the component-level lock is acquired at the waiting phase and released at the finalizing phase.

The memory bucket is the unit of concurrency for space management. Space management operations, including allocations and deallocations, are serialized at the bucket level. A bucket is a self-descriptive unit of contiguous allocation units (extents). The lock is per memory bucket (i.e., bucket-level lock), and the defragmentation takes the bucket as the unit to perform defrag (i.e., each defragmentation process only defragments extents among the same bucket).

### Cost-Based Algorithm for Source-Destination Mapping

FIG. 4 is a flowchart illustrating operation of a cost-based algorithm for selecting source extent and destination extent pairs for defragmentation in accordance with an embodiment. Operation begins during the selection phase of the defragmentation process being performed on a memory bucket (block 400), and the selection algorithm initializes the extent pair set S as an empty set (block 401). The selection algorithm computes a cost for each extent in the bucket (block 402). As described above, in some embodiments, the system uses a hierarchical extent structure. In these embodiments, the cost for moving an extent B is as follows:

$$cost ( B ) = cost of moving B + cost of moving children from volatile bitmap$$

The selection algorithm then computes the optimal number of free extents for each extent size (block 403). For each extent size, the optimal number of free extents is as follows:

$${optimal}_{fre {e}_{e x t e n t s [ s i z e ]}} = ( total free bytes ) / ( extent size )$$

Then, the selection algorithm sorts extents by size in descending order (block 404).

The selection algorithm marks extents for moving (block 405). For each extent B in sorted extents, the selection algorithm performs the following:
If B has the lowest cost among its peers:
   Mark all its children for moving;
If B itself is marked for moving:
   Find an extent B′ with the lowest cost that is not marked and is free;
   Mark all children of B′ for moving;
Break if the number of free extents (including the marked ones)==
   optimal_free_extents[size].

Next, for each extent marked for moving, the selection algorithm finds a free extent to be the destination extent (block 406). For each extent B in extents marked for moving, the selection algorithm performs the following:
Find a free extent B′ that satisfies:
   B′ must be free, and
   All parents of B′ must not be marked for moving;
Add (B→B′) to solution set S.

The selection algorithm returns the solution set S (block 405), and operation ends (block 407).

### Hardware Overview

According to one embodiment, the techniques described herein are implemented by one or more special-purpose computing devices. The special-purpose computing devices may be hard-wired to perform the techniques or may include digital electronic devices such as one or more application-specific integrated circuits (ASICs) or field programmable gate arrays (FPGAs) that are persistently programmed to perform the techniques or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

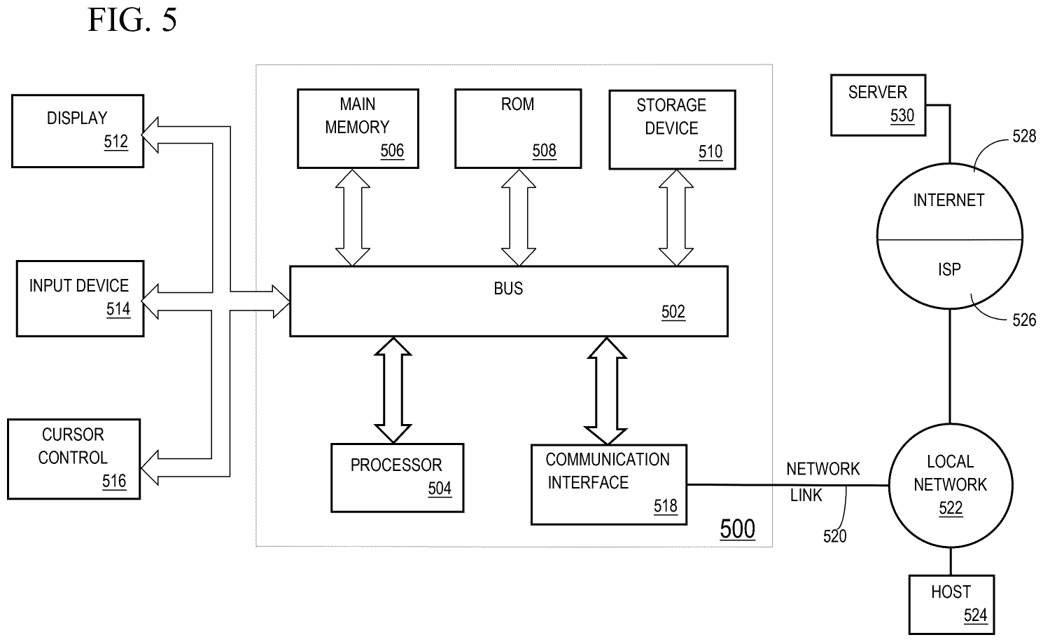

For example, FIG. 5 is a block diagram that illustrates a computer system 500 upon which aspects of the illustrative embodiments may be implemented. Computer system 500 includes a bus 502 or other communication mechanism for communicating information, and a hardware processor 504 coupled with bus 502 for processing information. Hardware processor 504 may be, for example, a general-purpose microprocessor.

Computer system 500 also includes a main memory 506, such as a random-access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk, optical disk, or solid-state drive is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 510. Volatile media includes dynamic memory, such as main memory 506. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid-state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic, or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world-wide packet data communication network now commonly referred to as the “Internet” 528. Local network 522 and Internet 528 both use electrical, electromagnetic, or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

### Software Overview

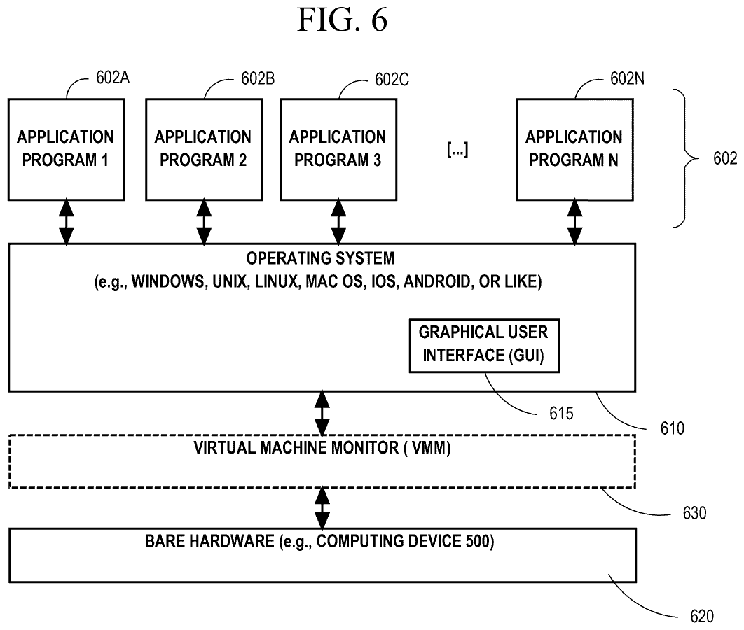

FIG. 6 is a block diagram of a basic software system 600 that may be employed for controlling the operation of computer system 500. Software system 600 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 600 is provided for directing the operation of computer system 500. Software system 600, which may be stored in system memory (RAM) 506 and on fixed storage (e.g., hard disk or flash memory) 510, includes a kernel or operating system (OS) 610.

The OS 610 manages low-level aspects of computer operation, including managing execution of processes, memory allocation, file input and output (I/O), and device I/O. One or more application programs, represented as 602A, 602B, 602C . . . 602N, may be “loaded” (e.g., transferred from fixed storage 510 into memory 506) for execution by system 600. The applications or other software intended for use on computer system 500 may also be stored as a set of downloadable computer-executable instructions, for example, for downloading and installation from an Internet location (e.g., a Web server, an app store, or other online service).

Software system 600 includes a graphical user interface (GUI) 615, for receiving user commands and data in a graphical (e.g., “point-and-click” or “touch gesture”) fashion. These inputs, in turn, may be acted upon by the system 600 in accordance with instructions from operating system 610 and/or application(s) 602. The GUI 615 also serves to display the results of operation from the OS 610 and application(s) 602, whereupon the user may supply additional inputs or terminate the session (e.g., log off).

OS 610 can execute directly on the bare hardware 620 (e.g., processor(s) 504) of computer system 500. Alternatively, a hypervisor or virtual machine monitor (VMM) 630 may be interposed between the bare hardware 620 and the OS 610. In this configuration, VMM 630 acts as a software “cushion” or virtualization layer between the OS 610 and the bare hardware 620 of the computer system 500.

VMM 630 instantiates and runs one or more virtual machine instances (“guest machines”). Each guest machine comprises a “guest” operating system, such as OS 610, and one or more applications, such as application(s) 602, designed to execute on the guest operating system. The VMM 630 presents the guest operating systems with a virtual operating platform and manages the execution of the guest operating systems.

In some instances, the VMM 630 may allow a guest operating system to run as if it is running on the bare hardware 620 of computer system 500 directly. In these instances, the same version of the guest operating system configured to execute on the bare hardware 620 directly may also execute on VMM 630 without modification or reconfiguration. In other words, VMM 630 may provide full hardware and CPU virtualization to a guest operating system in some instances.

In other instances, a guest operating system may be specially designed or configured to execute on VMM 630 for efficiency. In these instances, the guest operating system is “aware” that it executes on a virtual machine monitor. In other words, VMM 630 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g., content of registers) between allotments of the hardware processor time when the computer system process is not running. Computer system processes run under the control of an operating system and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

1. A method comprising:
performing a defragmentation operation on a particular bucket of persistent memory of a particular host, wherein:
the particular host stores, in the persistent memory, a plurality of database components,
the persistent memory is segmented into one or more buckets including the particular bucket,
the particular bucket comprises one or more extents,
each extent of the one or more extents has a size corresponding to a number of allocation units of the persistent memory,
each extent is allocated to a corresponding database component of the plurality of database components,
performing the defragmentation operation comprises:
selecting a set of extent pairs, wherein:
each extent pair comprises a source extent and a destination extent, and
the destination extent is a free extent within the particular bucket having a same size as the source extent;
for each given extent pair comprising a given source extent allocated to a given database component and a given destination extent:
quiescing the given database component;
copying data from the given source extent to the given destination extent; and
unquiescing the given database component,
wherein the method is performed by one or more computing devices.

2. The method of claim 1, further comprising:
prior to copying data from the given source extent to the given destination extent, acquiring a component-level lock on the given database component, and
after copying data from the given source extent to the given destination extent, releasing the component-level lock on the given database component.

3. The method of claim 1, wherein quiescing the given database component comprises preventing new writers to the given source extent and waiting for existing writers to the given source extent to complete.

4. The method of claim 1, wherein:
an extent map stores an address in the memory for each of the one or more extents, and
copying the data from the given source extent to the given destination extent comprises updating the extent map to reflect a memory address of the given destination extent.

5. The method of claim 1, wherein selecting the set of extent pairs comprises selecting the set of extent pairs using a cost-based greedy algorithm.

6. The method of claim 5, wherein selecting the set of extent pairs using the cost-based greedy algorithm comprises:
initializing a solution set of extent pairs as an empty set;
computing a cost for each allocated extent in the particular bucket;
computing an optimal number of free extents for each extent size;
sorting allocated extents by extent size in descending order;
mark a set of source extents for moving from the sorted allocated extents;
for each extent in the set of source extents, identifying a corresponding destination extent to form an extent pair; and
adding each extent pair to the solution set.

7. The method of claim 1, wherein performing the defragmentation operation further comprises:
acquiring a bucket-level lock on the particular bucket; and
prior to selecting a set of extent pairs, determining that a blocking sign indicates the particular bucket is not involved in an ongoing defragmentation.

8. The method of claim 7, wherein performing the defragmentation operation further comprises:
setting the blocking sign to indicate the particular bucket is involved in an ongoing defragmentation; and
releasing the bucket-level lock on the particular bucket.

9. The method of claim 1, further comprising:
after performing the defragmentation operation, acquiring a bucket-level lock on the particular bucket;
setting a blocking sign to indicate the particular bucket is not involved in an ongoing defragmentation; and
releasing the bucket-level lock on the particular bucket.

10. The method of claim 1, wherein the given database component comprises an index, a row heap, a row storage, transaction heap, or a mapping to log record.

11. One or more non-transitory computer-readable media storing instructions which, when executed by one or more processors, cause:
performing a defragmentation operation on a particular bucket of persistent memory of a particular host, wherein:
the particular host stores, in the persistent memory, a plurality of database components,
the persistent memory is segmented into one or more buckets including the particular bucket,
the particular bucket comprises one or more extents,
each extent of the one or more extents has a size corresponding to a number of allocation units of the persistent memory,
each extent is allocated to a corresponding database component of the plurality of database components,
performing the defragmentation operation comprises:
selecting a set of extent pairs, wherein:
each extent pair comprises a source extent and a destination extent, and
the destination extent is a free extent within the particular bucket having a same size as the source extent;
for each given extent pair comprising a given source extent allocated to a given database component and a given destination extent:
quiescing the given database component;
copying data from the given source extent to the given destination extent; and
unquiescing the given database component.

12. The one or more non-transitory computer-readable media of claim 11, wherein the instructions, when executed by the one or more processors, further cause:
prior to copying data from the given source extent to the given destination extent, acquiring a component-level lock on the given database component, and
after copying data from the given source extent to the given destination extent, releasing the component-level lock on the given database component.

13. The one or more non-transitory computer-readable media of claim 11, wherein quiescing the given database component comprises preventing new writers to the given source extent and waiting for existing writers to the given source extent to complete.

14. The one or more non-transitory computer-readable media of claim 11, wherein:
an extent map stores an address in the memory for each of the one or more extents, and
copying the data from the given source extent to the given destination extent comprises updating the extent map to reflect a memory address of the given destination extent.

15. The one or more non-transitory computer-readable media of claim 11, wherein selecting the set of extent pairs comprises selecting the set of extent pairs using a cost-based greedy algorithm.

16. The one or more non-transitory computer-readable media of claim 15, wherein selecting the set of extent pairs using the cost-based greedy algorithm comprises:
initializing a solution set of extent pairs as an empty set;
computing a cost for each allocated extent in the particular bucket;
computing an optimal number of free extents for each extent size;
sorting allocated extents by extent size in descending order;
mark a set of source extents for moving from the sorted allocated extents;
for each extent in the set of source extents, identifying a corresponding destination extent to form an extent pair; and
adding each extent pair to the solution set.

17. The one or more non-transitory computer-readable media of claim 11, wherein performing the defragmentation operation further comprises:
acquiring a bucket-level lock on the particular bucket; and
prior to selecting a set of extent pairs, determining that a blocking sign indicates the particular bucket is not involved in an ongoing defragmentation.

18. The one or more non-transitory computer-readable media of claim 17, wherein performing the defragmentation operation further comprises:
setting the blocking sign to indicate the particular bucket is involved in an ongoing defragmentation; and
releasing the bucket-level lock on the particular bucket.

19. The one or more non-transitory computer-readable media of claim 11, wherein the instructions further cause:
after performing the defragmentation operation, acquiring a bucket-level lock on the particular bucket;
setting a blocking sign to indicate the particular bucket is not involved in an ongoing defragmentation; and
releasing the bucket-level lock on the particular bucket.

20. The one or more non-transitory computer-readable media of claim 11, wherein the given database component comprises an index, a row heap, a row storage, transaction heap, or a mapping to log record.
